(19) United States
(12) Patent Application Publication
(10) Pub. No.: US 2016/0003933 A1
(43) Pub. Date: Jan. 7, 2016

(54) LOCATION OF A DISTRESS BEACON

(71) Applicants: THALES, COURBEVOIE (FR); CENTRE NATIONAL D'ETUDES SPATIALES, Paris (FR)

(72) Inventors: Thibaud Pierre Jean CALMETTES, TOULOUSE (FR); Emanuela Ana Maria PETCU, TOULOUSE (FR); Yoan GREGOIRE, TOULOUSE (FR)

(21) Appl. No.: 14/789,767

(22) Filed: Jul. 1, 2015

(30) Foreign Application Priority Data
Jul. 4, 2014 (FR) 14 01510

(51) Int. Cl. G01S 5/00; G01S 19/42; G01S 19/17

(52) U.S. Cl. CPC G01S 5/0072; G01S 19/17; G01S 19/42

(57) ABSTRACT

There is disclosed a computer implemented method for processing the signal emitted by a distress beacon, the signal being received by several satellites and forwarded to at least one ground station, the method comprising the steps consisting in determining a set of hypothetical positions of the beacon, and for at least one of the hypothetical positions, for each satellite, offsetting the signal received and forwarded as a function of the hypothetical position; summing the offset signals; and evaluating the validity of the sum of the offset signals as a function of the presence of a predefined characteristic in the sum. Developments describe aspects such as the temporal and/or frequency offsetting, the construction of a digital replica of the signal transmitted by the beacon, and as the minimizing of the weighted residues of the offsets. System aspects are described, including the calibration of an active antenna or an array of antennas.

### CROSS-REFERENCE TO RELATED APPLICATION

This application claims priority to foreign French patent application No. FR 1401510, filed on Jul. 4, 2014, the disclosure of which is incorporated by reference in its entirety.

### FIELD OF THE INVENTION

The invention relates to the field of satellite communications and in particular that of the procedures and methods for locating a distress beacon.

### BACKGROUND

A distress beacon or “radio beacon” for locating incidents is a transmitter which transmits an emergency electromagnetic signal (better known as a “burst”) to give the position of a ship, an airplane or an individual in distress. This signal is received by one or more satellites of a network (for example Cospas-Sarsat or GEOSAR) which generally forward this signal to ground stations which determine the location of the beacon and transmit the coordinates thereof to the nearest search and rescue center.

The signal may contain information about the position taken by GPS, making the location easier. In other situations, no declared position information is transmitted. In most instances, the vast majority of beacons on the market do not allow association with an identifier that is unique with each beacon.

As part of the development of the MEOSAR system, which is a search and rescue distress satellite network, due to enter service in 2018, numerous MEOLUT ground receiver stations need to be developed and deployed.

One of the main technical problems with the switch to MEOSAR is the degradation in the link budget with respect to the current LEOSAR version. If the LEOSAR (low altitude) system was set up with enough of a margin to allow MEOSAR processing despite this loss, all of this margin would need to be absorbed by the modification to the satellite segment whereas it normally could or should also cover the most critical transmission cases. In fact, there is a risk that an antenna that is poorly oriented and/or lacking in transmission power, or alternatively a beacon that is partially submerged might not be located in the future.

To date, there are a number of actions in place (or planned) for minimizing the losses associated with the switch to MEOSAR: a) the use of large receiving antennas in order to minimize the contribution of the downlink (in the knowledge that with the SAR-P payload there is just one uplink in the LEOSAR context); b) overall improvement in visibility: the geometric diversity permitted by having numerous (at least 8) satellites simultaneously in view on a permanent basis means that the constraints on masking and antenna gain combination are rated for a more favorable situation than for LEOSAR; c) improvement of the satellite antenna d) investigation into a new and better modulation (Cospas/Sarsat EWG).

Despite all these factors, the loss associated with the switch to MEOSAR leads to a 10 dB degradation. In addition, one key problem is the cost of the antenna which means that the number of satellites tracked is limited vary greatly, typically to 4 or 5 (with a maximum of 8 for the most well endowed MEOLUT stations, although some on the other hand have just two antennas), whereas 30 satellites are typically visible across all of the constellations tracked.

There is an industrial need for methods and systems that allow improved-precision location. The solution of the present invention addresses the disadvantages of the conventional approaches, at least in part.

### SUMMARY OF THE INVENTION

There is divulged a method implemented by a computer for processing the signal emitted by a distress beacon, said signal being received by several satellites and forwarded to at least one ground station, the method comprising the steps consisting in determining a set of hypothetical positions of the distress beacon; and for at least one of the hypothetical positions, for each satellite, offsetting the signal received and forwarded as a function of said hypothetical position; summing the offset signals and evaluating the validity of the sum of the offset signals as a function of the presence of a predefined characteristic in said sum.

The beacon in physical reality has a “true” (i.e. exact) position, the object of the present invention being specifically to determine the coordinates thereof as quickly and as precisely as possible.

On receipt of a signal transmitted by a beacon, to a first approximation, a first geographical zone within which the beacon is situated can be determined. By defining a certain resolution pitch (for example 5 km), a finite number of positions in space can be defined: the search space is discretized.

A set of “hypothetical” or “likely” or “possible” or “candidate” or “potential” positions is determined, in a discrete and therefore approximated manner. In reality, the distress beacon may be situated between two discretized positions. The position of the beacon is pinpointed iteratively when the best point(s) of the grid is or are determined.

This set of positions, according to various embodiments, corresponds to a “grid” or to a “matrix” or to a “table” or to a “net”. A logic or abstract view will in fact consider the list of possible positions as being coordinate data whereas a geometric view may correspond to a regular or irregular net. For example, it is possible to have a net that is irregular on positions (in order to take into consideration the fact that the degrees of longitude become more closely spaced as latitude increases). In general, a set of hypothetical positions is determined, whatever the underlying naming of the representation of the coordinates thus established. The set of potential positions of the beacon in a grid of positions allows the space of the possibles to be discretized and rapid convergence towards a precise position. Beyond the literal sense, in one particular embodiment, the grid of positions may be obtained by generating a finite set of geographic coordinates at which the beacon could be situated (for example to a first approximation). The location “pivot” is given by the list of the positions in the grid. A grid of positions is, for example, a grid of 1°×1° in latitude and in longitude. Considering the entire planet, 180×360, namely 64800 points may be obtained. By considering only the points visible from the station, this number of positions can be reduced by a factor of 5 (the exact number is dependent on the latitude), namely around 13000 points.

According to one aspect of the invention, “coherent integration” of the signals of the satellites is performed at a hypothetical position (or point of the grid of positions). Borrowed from the technical field of GNSS signals, this “coherent integration” in one particular embodiment corresponds to the “sum of the offset signals” from the satellites. The signals are offset (“in relative terms”), i.e. with respect to one another (according to the assumption of transmission position). It is the relative offset between the signals that is taken into consideration (not the absolute offset).

The “vector search”—which is then undertaken—denotes the operation of running through this set of positions or grid of positions in order to obtain a valid coherent integration, rather than searching through all of the possible time and frequency offsets between all the satellites, as this would create far too high a set of combinations.

The “validity” (or the “quality” of the sum) can be evaluated in different ways, the following developments giving various implementation solutions. In general, validity of the summed signal (i.e. of the offset signals) can be quantified, hence the term evaluation implying association with various values. This evaluation or quantification may for example be carried out as a function of the presence—or on the other hand the absence—of a predefined or known signal (i.e. the presence of a certain characteristic in the summed signal). If a predefined and/or known characteristic is absent, e.g. below a certain predefined threshold value, which is possibly one that can be configured), the position assumption (i.e. whereby a signal has been transmitted from the hypothetical particular position on the grid of positions) is abandoned for that grid point considered and the method is iterated. If a predefined and/or known characteristic is recognized or identified or detected or otherwise established as being similar (e.g. by the use of criteria and/or thresholds), the position hypothesis is maintained and other steps continue the tests of validating the hypothesis (e.g. demodulation, TOA/FOA measurements). Other subsequent rejection points may arise (for example the number of binary errors when decoding the BCH code notably for demodulation in Cospas-Sarsat). If the presence or absence of a predefined and/or known characteristic is not established for certain (e.g. interval or level of confidence either limited or insufficient), the signal is compared with respect to white noise so as to determine a useful signal (for example using thresholds and compromises between detection probability—e.g. ability to validate a signal received with a low signal-to-noise ratio—and the probability of a false alarm—e.g. the risk of performing the test processing operation on noise.

In one particular embodiment there is divulged a method implemented by a computer for processing the signal emitted by a distress beacon, said signal being received by several satellites and forwarded to at least one ground station, the method comprising the steps consisting in generating a grid of positions of the distress beacon, each grid point representing a hypothesis regarding the position of the beacon; summing the offset signals from the satellites at each point of said position grid; and determining the validity of each sum of the offset signals as a function of the presence or absence of a predefined characteristic in the transmitted signal.

Several steps are combined according to the method: a “vector” search is implemented on a “grid of positions” (i.e. candidate or potential positions) of the distress beacon, this search being carried out on the so-called “coherent” (i.e. using the summing of the relative offset signals from the satellites) and “valid” (i.e. by means of searching for and identifying the presence of a predefined characteristic contained in the signal transmitted by the distress beacon) integration of the signals from the various satellites at each point of the set of hypothetical positions (e.g. the “grid of positions” as defined). In one development, the step consisting in offsetting the signal from one satellite comprising a step consisting in offsetting the signal from said satellite temporally by a time that is equal to the opposite of the beacon-satellite-station propagation time.

The propagation time corresponds to the time of the total journey of the distress signal, namely the time taken to cover the distance between the hypothetical position of the distress signal and the satellite, added to the time taken to cover the distance between the satellite and the receiving station. This journey takes place at the speed at which an electromagnetic signal is transmitted, namely substantially the speed of light in a vacuum.

In one development, the step consisting in offsetting the signal from one satellite comprises a step consisting in offsetting the signal from the satellite in terms of frequency by a frequency equal to the opposite of the Doppler effect. The Doppler effect is associated with the relative movement of the satellite with respect to the hypothetical position of the distress beacon and with respect to the relative movement of the satellite with respect to the receiving station.

In one development, the step consisting in offsetting the signal from a satellite comprises a step consisting in offsetting the signal in terms of power by a power equal to the opposite of the power attenuation measured for said satellite.

The power attenuation is determined by (a) the losses in link budget between the hypothetical position of the distress beacon and the satellite and by (b) the losses in link budget between the satellite and the receiving station, the link budget losses being essentially made up of free space losses, itself dependent (i) on the distance and dependent (ii) on the antenna gains in transmission and in reception, said antenna gains being in turn dependent on the elevation and azimuth of transmission and reception.

Insofar as satellite orbits can be sufficiently well determined, it is also conceivable to correct the arrival phase. This development remains wholly optional (the estimate of the validity of the sum is performed non-coherently, i.e. assuming the phases to be different).

In one development, a characteristic of the transmitted signal comprises the presence of a pure carrier, and the validity of the sum of the offset signals from the satellites is determined by the appearance of a line in the Fourier transform of the summed signal.

In this particular case, for which the signal begins as pure carrier, it is possible not to compensate for the lag but compensate only for the Doppler effect because an FFT (Fast Fourier Transform) spike occurs as soon as the Doppler is fully corrected.

In one development, the signal transmitted further comprises the presence of a synchronization signal, and the validity of the sum of the offset signals from the satellites is determined by correlation between the summed signal and a replica of said synchronization signal.

The signal transmitted by the distress beacon may comprise a synchronization “signal” (for example and in one particular case a synchronization “word”). In one advantageous embodiment, the synchronization signal has the same properties as the useful signal which follows (for example the same modulation).

Various modulations of the “Search and Rescue” S.A.R. system are possible. The current modulation used considers a carrier followed by the message, the message beginning with a predefined sequence. What is referred to as the “new generation” modulation considers the message directly, but with a predefined known sequence at the start of the transmission of the signal and with a spread code. Such a sequence is a marker, useful and advantageous for the validity of the coherent integration step. In the case of modulation with pure carrier, a composition is considered to be valid if the coherent summing causes a line to appear graphically in the frequency domain. The signal emitted by the distress beacon may comprise a predefined message portion marking the start of the transmission. If the transmitted signal comprises a predefined (i.e. known beforehand) marker, a composition is considered to be valid if the correlation with the predefined message portion causes a line to appear graphically in the time/frequency domain. In other words, a “spike” may appear when searching for synchronization in the frequency and time domains.

This development corresponds to signals referred to as “search and rescue” signals. Checks are first of all conducted as to whether there is a line and, if there is a line, then the synchronization word is searched for. This development offers better operational performance. In particular the search for correlation makes it possible to eliminate detections on parasitic lines associated with interference, and looking for the line before looking for the correlation means that the frequency uncertainty can be reduced and the calculation complexities can be kept compatible with implementation in real time.

In one development, correlation is obtained for a particular temporal and frequency offset between said signal obtained by summing the offset signals from the satellites and the replica of the synchronization word.

The search for the particular temporal and frequency offset can be carried out by calculating the correlation for each position of the set of hypothetical positions comprising a temporal offset and frequency offset (i.e. with no direct connection to the hypothetical position of the distress beacon).

The method involves defining a set of hypothetical positions of the distress beacon. Using iteration, one particular hypothetical position is considered. For this position, the signals from each satellite are offset temporally and in frequency, specifically as a function of the hypothetical position considered, and the Doppler lags and offsets associated with the propagation of the signal. These modified signals are summed. For example, if the signals from four satellites are dubbed s1, s2, s3 and s4 and the function for offsetting the signal s according to the hypothetical position p is dubbed f(s,p), then the resultant summed signal S will be S(p)=f(s1,p)+f(s2,p)+f(s3,p)+f(s4,p). In this summed signal S, a search or test or evaluation is carried out to determine whether S(p) contains an intelligible signal, e.g. comprising a known signal. To do this, one method is to correlate S(p) with a replica of the synchronization word. If S(p) and the replica are indeed aligned in frequency and in time, the correlation will be strong and a high value thereof will be observed, allowing the hypothesis of position p to be validated. However, in the general case, S(p) and the replica will not be aligned because the date and transmission frequency of the signal are not known. In order to take the lack of knowledge of transmission date and transmission frequency into consideration, a (“regular”) grid of offsets may be created (transmission time offset, transmission frequency offset) and subsequently the correlation with the replica will be able to be calculated for each of the points of this grid. The sum S(p) will be valid if a point in this grid is identified, for which point the correlation with the replica is high. Incidentally, knowledge and manipulation of S(p) is the only thing required (position information is no longer needed). Iteratively then, the position of the distress beacon can be determined.

This particular embodiment is advantageous for methods of formulating the validity of the coherent integration (e.g. sum of the offset signals). The time/frequency grid corresponds to the two unknowns, the “message transmission date” and the “message transmission frequency”. The uncertainty over these elements does not prevent coherent reconstruction using the process of precompensating for Doppler shift and lag according to the position grid, although if they are not correctly estimated/known, they may disrupt the validity search processes.

In one development, a characteristic of the emitted signal is obtained by combining an initial message and a spread code, and the validity of the sum of the offset signals from the satellites is determined by correlation between the summed signal and a replica of the spread code.

In one development, the correlation is determined for a particular temporal and frequency offset between the summed signal and the replica of the spread code.

In one development, the method further comprises, for each satellite, a step consisting in determining a time offset and a frequency offset that maximize the correlation between the signal received from this satellite and the summed signal corresponding to the sum of the offset signals from the satellites that is determined as being valid.

In this development, it is advantageous to be able to evaluate the time and frequency offset measurements without having demodulated and reconstructed the replica. This is not so precise (because the replica is made without noise, whereas the coherent integration always has a nose residue), but still works, and may notably allow a location to be made even if the binary content has not been able to be demodulated. According to this development, a pair comprising a time offset and a frequency offset is thus determined for each satellite.

In one development, the method further comprises, for each sum of offset signals from the satellites which is determined as being valid, a step consisting in determining the binary content of the signal transmitted by the beacon, relayed by the satellites and received by the station.

Demodulation does not strictly speaking form part of the satellite coherent integration.

In one development, the method further comprises, for each sum of offset signals from the satellites which is determined as being valid, after the step consisting in determining the binary content of the signal transmitted by the beacon, a step consisting in constructing a baseband digital replica of the signal transmitted by the distress beacon.

To reconstitute the signal transmitted by the distress beacon, there is no need to know the propagation medium in order to reconstruct this “backward” and determine distortions. This then here is a “baseband” reconstruction. It is a matter of constructing a modulated signal with no carrier offset.

In one development, the method further comprises, for each satellite, a step consisting in determining a time offset and a frequency offset that maximize the correlation between the signal received from this satellite and the digital replica after a step consisting in demodulating the coherent composition.

The “digital replica” corresponds to the signal transmitted by the beacon as reconstituted after coherent integration. The expression “from this satellite” means “relayed by the satellite considered and sent to the ground station”. In the MEOSAR system, the system undergoes no processing in the satellite before being forwarded to the station.

To simplify, comparisons are made, on the ground, between the reconstituted (from the signal derived from the multisatellite coherent integration) transmitted signal and each of the isolated real signals in turn which are received by each satellite considered individually.

For each satellite, a (time offset; frequency offset) pair is therefore determined. The time and frequency offsets evaluated here correspond to residues with respect to those considered in the creation of the valid sum of the offset signals. For the “true” position of the beacon, for a given satellite, the (time and/or frequency) offset is denoted D. For the grid point positioned closest to the true position of the beacon, an offset D1 has been used. By considering a grid pitch that is small enough, the difference between D1 and D has been small enough that the coherent integration, the search for validity therein, and the demodulation have acceptable losses. However, the processing step that is most demanding with respect to the measurement of D is the step of precisely locating the transmitter. It may therefore happen that this difference between D1 and D is too great for the location to be evaluated precisely (this being the process most dependent on measurement precision) and there will therefore be a need for a more precise measurement of D. When the sum has been constructed with precompensation for offset, the satellite signal has been offset by D1 such that the reference signal (the signal served directly from the sum of the offset signals or the replica signal) used for measuring the “time offset, frequency offset” is already offset by D1. Thus, the search for correlation between the satellite signal and the reference signal will yield a residual offset value D2, and that which will be used for location as the best estimate of D1 will be equal to the sum of D1 and D2.

In one particular embodiment, the time and/or frequency measurements can be initialized on the basis of the previously described preliminary measurements taken (e.g. temporal offset of the satellite signal by a time equal to the opposite of the beacon-satellite-station propagation time and/or frequency offset of the signal from the satellite by a frequency equal to the opposite of the Doppler effect).

In one development, the method further comprises a step consisting in determining the location of the distress beacon, said location minimizing the weighted residue of the time offsets or the weighted residue of the frequency offsets, or the combined weighted residue of the time offsets and of the frequency offsets between the satellites.

The weighted residues can be minimized using the Gauss-Newton algorithm. Time and frequency measurements are combined. According to the waveform (in particular), either the time or the frequency will be associated with a higher confidence interval. Certain satellites may give better or worse measurements. In one development, the method further comprises a step consisting in calibrating an active antenna or an array of antennas as a function of the location of the distress beacon.

In one development, the method further comprises a step consisting in creating an alert bulletin comprising the demodulated content of the signal transmitted by the beacon and/or the determined location of the distress beacon.

In one embodiment, the alert bulletin may comprise the demodulated content of the transmitted signal and/or the location (if it is determined for example). In other words, it is equally possible to create an alert bulletin containing only the demodulated content (for subsequent processing operations or third parties for example), i.e. without determining the location of the beacon (which therefore remains an optional characteristic at this stage in the method).

In an entirely optional development, the method comprises beforehand a step consisting in removing the contribution of the downlink between the satellite and the ground station or stations.

The operation aimed at “offsetting the signal received from a satellite” consists in compensating for what is referred to as the uplink (from the position of the beacon to the satellite) and what is referred to as the downlink (from the satellite to the ground station). Because the downlink is not dependent on the position of the beacon, it is possible to calculate its contribution in common across all of the set of hypothetical positions. This embodiment is advantageous insofar as calculation is concerned.

In particular, this removal of the downlink contribution can be carried out before the search is applied to the points of the grid of hypothetical positions of the distress beacon. This (optional) development corresponds to an optimization of the calculations. In a simple embodiment, Doppler lags and shift values are removed from the entire path (from the beacon to the satellite and then from the satellite to the station). In practice, for all points on the grid, the path from the satellite to the station may be substantially the same, which means that numerous calculations may prove to be superfluous. The present development proposes removing the contributions of the path of the signal from the satellite to the station once and for all, so that calculation resources can then concentration on matters dependent solely on the position of the beacon.

In one development, the set of hypothetical positions of the distress beacon is reduced to the positions visible from the satellites visible from the receiving station.

In particular, the pitch of the grid of expected positions of the distress beacon can be optimized (reducing the search space).

Determining the location of the distress beacon makes it possible, amongst other things, to anticipate or monitor further transmissions from the distress beacon.

Also divulged is a computer program product, said computer program comprising code instructions for running one or more steps of the method when said program is executed on a computer.

Also disclosed is a system for locating a distress beacon, the system comprising means for implementing one or more steps of the method.

In one development, the system comprises at least one active antenna or an array of antennas.

According to one aspect of the invention, an (optional) array of antennas is used in combination with multi-satellite parallel processing. In particular, the results of the processing are “looped back” on the calibration of the antenna array.

Amongst other advantages, the method allows all the visible satellites to be processed simultaneously with no significant cost impact on the modifications made to the antennas. Conversely, the signal processing sequence is improved. The calibration of the antenna array can be optimized. In general, each segment or step of the processing sequence thus contributes to optimization and the improvement of the others.

The advantages of the method and of the system described include improvements to the performance and optimization on cost. The method makes it possible to contemplate a theoretical gain of 10×log (N), where N is the number of satellites visible. For N=30, the gain reaches 14 dB. An objective at 10 dB inclusive of losses can thus be legitimately contemplated. The method can be implemented at reduced cost for adapting the MEOLUT station (antenna array and software adaptations).

The software complexity (and also the hardware complexity as far as the RF of the antenna array is concerned) can thus in fact be easily overcome. Matlab experiments on single-core processors indicate that processing (with no particular optimization) is under a real time factor of 10. Implementation in C++ on computation servers will be advantageous. In terms of antennas, the targeted number of satellites (of the order of around 50) remains feasible for an industrial party (present-day systems contain up to 200 elements).

The present disclosure offers a number of ancillary benefits. According to one aspect, the steps described can be combined with one another even in “forward” in order progressively to enrich the estimate of the position of “backward” so as to use the final position of the beacon to true the array. In fact, an inbuilt mechanism that manages the quality of the measurements also becomes possible. The method also allows differences from expectation to be monitored. It also allows the detection of jammers formed. Finally, the method allows recalculations to be performed on accumulated data (ease of looking back into the past).

### BRIEF DESCRIPTION OF THE DRAWINGS

Various aspects and advantages of the invention will become apparent in support of the description of one preferred but nonlimiting embodiment of the invention, with reference to the figures hereinbelow:

FIG. 1 illustrates the overall operation of the existing methods for locating a distress beacon;

FIG. 2 schematically illustrates the multichannel optimization according to the invention and sets out various associated optimization possibilities.

### DETAILED DESCRIPTION

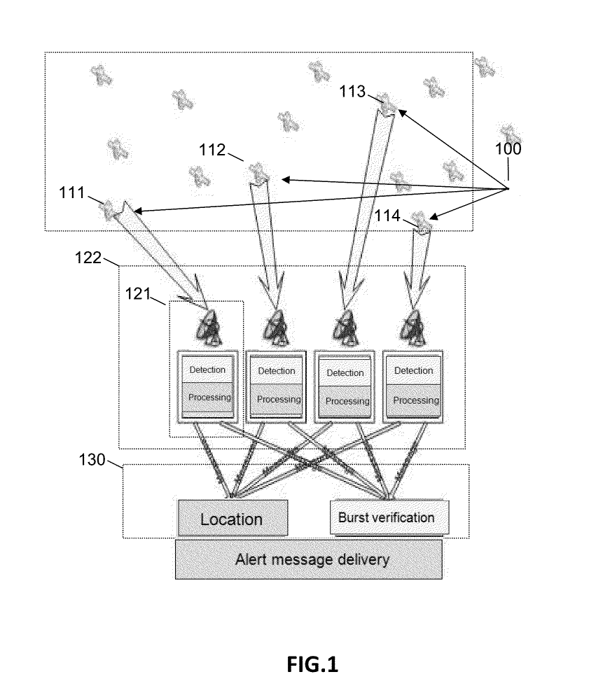

FIG. 1 illustrates the overall operation of the existing methods for locating a distress beacon. A beacon 100 transmits an electromagnetic signal, which is received by four satellites 111, 112, 113 and 114, from among a constellation of satellites. These four satellites forward the distress signal to the ground stations. The MEOLUT ground station 122 is made up of stations 121 of LEOLUT type. At the present time, around ten MEOLUT stations 122 are deployed worldwide. A LEOLUT 121 is associated with one antenna and sees just one satellite. Each LEOLUT station performs four successive FOA/TOA (time of arrival, frequency of arrival) measurements, with a Doppler measurement (the Doppler effect being strong at low altitudes). With four LEOLUT stations forming one MEOLUT, the beacon is located (the position of the satellites is known at each instant), with one single “burst”.

According to the prior art, these various stations 121 do not work together. The processing channels are independent. The architecture is separate or compartmentalized, with a detection and processing sequence specific to each antenna, the processing sequences being separated not only in software terms but also usually in hardware terms. The existing architecture is chiefly designed around the number of antennas (because of the significant cost of the antennas). In addition, of the thirty or so satellites potentially addressable, only four can actually be used simultaneously.

According to a first aspect of the invention, the antenna part is improved (because of the use of an array of antennas), although this feature still remains optional. This solution allows all or a much higher number of the satellites belonging to the constellation to be addressed. In practice, this array of antennas can see the thirty or so satellites of the constellation.

According to a second aspect of the invention, in combination with the (optional) use of the array of antennas, the processing of the signal is the subject of collaboration between the various LEOLUT stations 121. In other words, one aspect of the invention envisions multichannel optimization.

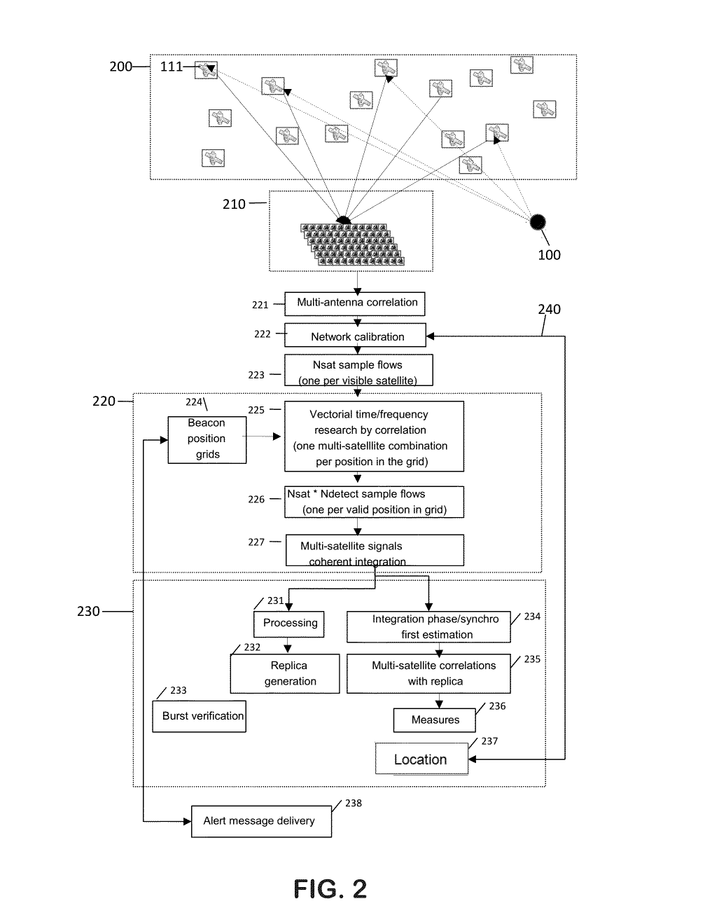

FIG. 2 schematically depicts the multichannel optimization according to the invention.

The method generally describes multi-antenna correlation for tracking of GNSS satellites. By means of an array of optional antennas, a vector search is conducted. A vector search is implemented in step 220 from a grid of expected positions (typical pitch 2°×2°) to verify that an SAR transmission is present by recombining the signals obtained on the various satellites visible from the grid point and MEOLUT. In step 230, the vector search is used as a starting point for implementing multisatellite coherent integration. In step 232, the integrated signal is processed. From this an ideal replica is deducted, then TOA/FOA measurements are constructed from a new iteration of correlations on this ideal replica. In step 238 an alert bulletin is produced. In step 240 the location finally obtained (together possibly with the vector search function in order to anticipate the presence of the next transmission from the same beacon) is forwarded to the antenna calibration sequence. In other words, integration is performed by looping back the results of the locations on the beacons processed in order to continually recalibrate the network.

An “active antenna” or “antenna array” 210 is a set of antennas which are separate and powered synchronously (the current phase shift between two pairs of antennas is fixed). The electromagnetic field produced by an antenna array is the vector sum of the fields produced by each of the elements. Through a suitable selection of spacing between the elements and the phase of the current passing through each, the directionality of the array can be modified using the constructive interference in certain directions and the destructive interference in other directions. The benefit of this type of array is that it is possible to change the direction in which the antenna “pulls” in a few microseconds (rather than seconds or tenths of a second which would be needed in order to orient a parabola mechanically. Several targets can be monitored simultaneously. Another advantage associated with this type of antenna is that these systems operate at a relatively low power.

In a step 220, a “vector” search is conducted on a grid of positions, this being followed by a coherent integration step 230.

In order to determine the location of the beacon iterations are in fact carried out in a grid, using a search mode said to be “vectorial” 220. The pitch of the grid can be optimized in various ways (the search space can be restricted by knowing which satellites are visible to the beacon and to the station, for example by excluding the zones of the earth's poles). Only the possible domain is swept. All the possible combinations are tested (frequency and time offsets). A search is therefore carried out over a grid of positions. Two unknowns still remain: the date and frequency of the “burst”. By proceeding by hypotheses, via several satellites, the signals are recombined using a multisatellite coherent integration.

In a first step, a position grid is swept. For each grid point the Dopplers and differential lags are calculated (for each satellite) and a corresponding (time/frequency) composition is created. If, at a certain frequency and at a certain date, the presence of a composition is found, it is validated.

In a second step, for each valid composition, the signal is demodulated then a digital replica of the burst (i.e. without any additional noise) is created.

In a third step, for each satellite, the time offset and frequency offset that maximize the correlation with the replica are sought. These offsets make it possible to find the precise location of the beacon. In other words, a coherent recombined signal is reconstructed and this recombined signal is varied in terms of time and in terms of frequency. These variations are compared with the actual signals, so as to improve the precision with which the beacon is located.

The information from the plurality of satellites lessens the precision with which the beacon is located and a step of iteratively calculating the path in the grid allows the beacon to be located more precisely. If the fineness of the grid is insufficient, “bursts” may be missed.

Each satellite receives the same signal from the beacon. Assuming that the position of the distress beacon is known, all the Dopplers are known and it is therefore possible coherently to sum the signals and the balance is improved (the signal is four times stronger). Combining the signals on all the satellites to improve the signal. This operation may advantageously be performed on all of the addressable satellites or on the greatest possible proportion thereof (something which is performed when an array of antennas is used).

An optional calibration step 240 allows the calibration of the array of antennas to be optimized continuously. An antenna element corresponds to a satellite. If there are phase offsets for an antenna element, it will be possible to readjust this element (for example the phase will be modified by a few degrees, using software). All the antennas generally become misadjusted over the course of time. Each beacon detection therefore provides the opportunity to recalibrate the antenna elements.

The various steps of the method can be combined with one another, i.e. implemented synergistically. The steps of vector detection 220, coherent combination 230, final location 237 and antenna calibration 240 are connected with the location of the beacon.

During the steps of vector detection, coherent combination then final location, increasingly fine estimates are made of the position and emission characteristics (time, frequency) of the beacon, and this tends toward reducing the uncertainty, ambiguities, false alarms and calculation time for successive steps. Conversely, precise location of the beacon will serve for retrospective calibration of the antenna array (revealing how the phase shifts observed by the multi-antenna correlation and the geometric origin of the signal are linked). The method makes it possible to formulate an inbuilt mechanism for managing the quality of the measurements, and this may notably manifest itself in a reduction of false alarms (so therefore in an improvement to performance by reducing the associated thresholds at each step of the processing) and the possibility of introducing a quality index. For example, if the final location step leads to a beacon position that is outside of the range of uncertainty of the coherent integration (namely if the beacon was actually situated at the position at which it was finally located, the coherent integration would not have been able to work and the signal would not have been able to be processed), the message can be rejected, or at the very least transmitted with a low level of confidence.

Another advantage of the method lies in the monitoring of deviations from the expected. For example, if, in a given situation, according to the vector search five given satellites ought to provide optimum visibility of the beacon (given their position and the position of the beacon in the grid), if it is found that one of these five satellites contributes absolutely nothing to the measurement, that could mean either that there is interference common to the beacon and this satellite only (which needs to be checked against other satellites and other beacons) or that there is an error with the calibration of the antenna on this satellite (which needs to be checked against other beacons) or finally that there is a problem with the satellite. In the event (notably) that degradation to the contribution made by one satellite to the correlation when performing a vector search is discovered, a specific recalibration to that satellite will advantageously be carried out (for example, by reverting to an earlier calibration that then was operating correctly and correcting it—or not—by the variation in position known from the satellite's orbit).

Up as far as the coherent integration steps, the processing is generally the same for a working signal or a jammer formed. Most of the jammer detection and location function is already natively included in the MEOLUT. The methods divulged may make it possible to spot relatively weak jammers (which would not be able to be detected by an existing MEOLUT with its single-channel processing).

The vector approach means that the past can be interrogated effectively. By way of illustration, if a burst was detected on a given date, it is conceivable to return to the earlier transmission (for example 50 seconds earlier) and reduce very greatly the vector search and coherent integration domains by considering knowledge of the position of the beacon so as to determine whether this time it is possible to extract the previous burst which may have been missed (or to confirm that it was indeed missed).

In the case of a satellite calibration defect, the signals may also be stored. If appropriate, a subsequent reliable detection on this satellite (on a strong orbitography beacon message for example) allows the antenna channel to be recalibrated (and, for example, the intermediate signal to be reprocessed at that particular time).

Also disclosed are a method and a system allowing vector processing (antenna, detection, processing) to be incorporated into one and the same serialized MEOLUT system. Also disclosed are various implementations of actions and feedback actions of the processing blocks on one another. Interferences and false alarms can be managed.

The present invention can be implemented using hardware and/or software elements. It may be available as a computer program product on a computer-readable support. The support may be electronic or magnetic, optical, electromagnetic or may be a diffusion support of the infrared diffusion type.

1. A method implemented by a computer for processing the signal emitted by a distress beacon, said signal being received by several satellites and forwarded to at least one ground station, the method comprising the steps:
determining a set of hypothetical positions of the distress beacon; and
for at least one of the hypothetical positions:
for each satellite, offsetting the signal received and forwarded as a function of said hypothetical position;
summing the offset signals by coherent integration; and
evaluating the validity of the sum of the offset signals as a function of the presence of a predefined characteristic in said sum.

2. The method as claimed in claim 1, the step consisting in offsetting the signal from one satellite comprising a step consisting in offsetting the signal from said satellite temporally by a time that is equal to the opposite of the beacon-satellite-station propagation time.

3. The method as claimed in claim 1, the step consisting in offsetting the signal from one satellite comprising a step consisting in offsetting the signal from the satellite in terms of frequency by a frequency equal to the opposite of the Doppler effect.

4. The method as claimed in claim 1, the step consisting in offsetting the signal from a satellite comprising a step consisting in offsetting the signal in terms of power by a power equal to the opposite of the power attenuation measured for said satellite.

5. The method as claimed in claim 1, for which a characteristic of the transmitted signal comprises the presence of a pure carrier, and in which the validity of the sum of the offset signals from the satellites is determined by the appearance of a line in the Fourier transform of the summed signal.

6. The method as claimed in claim 1, for which the signal transmitted further comprises the presence of a synchronization signal, and for which the validity of the sum of the offset signals from the satellites is determined by correlation between the summed signal and a replica of said synchronization signal.

7. The method as claimed in claim 6, for which correlation is obtained for a particular temporal and frequency offset between said signal obtained by summing the offset signals from the satellites and said replica of the synchronization word.

8. The method as claimed in claim 1, a characteristic of the emitted signal being obtained by combining an initial message and a spread code, and the validity of the sum of the offset signals from the satellites being determined by correlation between the summed signal and a replica of the spread code.

9. The method as claimed in claim 8, the correlation being determined for a particular temporal and frequency offset between the summed signal and the replica of the spread code.

10. The method as claimed in claim 1, further comprising, for each satellite, a step consisting in determining a time offset and a frequency offset that maximize the correlation between the signal received from this satellite and the summed signal corresponding to the sum of the offset signals from the satellites that is determined as being valid.

11. The method as claimed in claim 1, further comprising, for each sum of offset signals from the satellites which is determined as being valid, a step consisting in determining the binary content of the signal transmitted by the beacon, relayed by the satellites and received by the station.

12. The method as claimed in claim 1, further comprising, for each sum of offset signals from the satellites which is determined as being valid, after the step consisting in determining the binary content of the signal transmitted by the beacon, a step consisting in constructing a baseband digital replica of the signal transmitted by the distress beacon.

13. The method as claimed in claim 1, further comprising, for each satellite, a step consisting in determining a time offset and a frequency offset that maximize the correlation between the signal received from this satellite and the digital replica after a step consisting in demodulating the coherent composition.

14. The method as claimed in claim 1, further comprising a step consisting in determining the location of the distress beacon, said location minimizing the weighted residue of the time offsets or the weighted residue of the frequency offsets, or the combined weighted residue of the time offsets and of the frequency offsets between the satellites.

15. The method as claimed in claim 14, further comprising a step consisting in calibrating an active antenna or an array of antennas as a function of the location of the distress beacon.

16. The method as claimed in claim 11, further comprising a step consisting in creating an alert bulletin comprising the demodulated content of the signal transmitted by the beacon and/or the determined location of the distress beacon.

17. The method as claimed in claim 1, comprising beforehand a step consisting in removing the contribution of the downlink between the satellite and the ground station or stations.

18. The method as claimed in claim 1, the set of hypothetical positions of the distress beacon being reduced to the positions visible from the satellites visible from the ground receiving station.

19. A computer program product, said computer program comprising code instructions for carrying out the steps of the method as claimed in claim 1 when said program is executed on a computer.

20. A system for locating a distress beacon, the system comprising means for implementing the steps of the method as claimed in claim 1.

21. The system as claimed in claim 20, comprising at least one active antenna or an array of antennas.
